(19) United States
(12) Patent Application Publication
(10) Pub. No.: US 2022/0129725 A1
(43) Pub. Date: Apr. 28, 2022

(54) METHOD AND SYSTEM FOR CONVOLUTION MODEL HARDWARE ACCELERATOR

(71) Applicant: VASTAI Holding Company, Grand Cayman (KY)

(72) Inventors: Lei Zhang, Richmond Hill (CA); Jun Qian, Shanghai (CN)

(21) Appl. No.: 17/310,419

(22) PCT Filed: Feb. 4, 2020
(86) PCT No.: PCT/CA2020/050136

§ 371 Date: Aug. 2, 2021

Related U.S. Application Data
(60) Provisional application No. 62/802,063, filed on Feb. 6, 2019.

(51) Int. Cl. G06N 3/04; G06N 3/063; G06F 9/50; G06F 7/76

(52) U.S. Cl. CPC G06N 3/04; G06F 7/76; G06F 9/5027; G06N 3/063

(57) ABSTRACT

A method and system for a convolution model hardware accelerator. The method comprises receiving a stream of an input feature map into the one or more processors utilizing a convolution model that includes a plurality of convolution layers, for a given convolution layer within the plurality of convolution layers, reconfiguring a computational order for a plurality of hardware accelerator sub-blocks by re-shuffling a plurality of output filters among the plurality of sub-blocks, and in accordance with the reconfigured computational order, generating output features that are interpretive of the input feature map.

### CROSS-REFERENCE TO RELATED APPLICATION(S)

This application is a continuation of International Application No. PCT/CA2020/050136 filed on Feb. 4, 2020, which claims priority to U.S. Application No. 62/802,062, filed on Feb. 6, 2019, the entire disclosures of which are hereby incorporated by reference.

### TECHNICAL FIELD

The disclosure herein relates to the field of processor techniques, devices and systems for machine learning models including convolution networks.

### BACKGROUND

Machine learning systems provide critical tools to advance new technologies including automatic speech recognition, autonomous vehicles, computer vision, and natural language understanding. Convolution models including convolution neural networks have been shown to be effective tools for performing image recognition, detection, and retrieval. Before a neural network can be used for these inference tasks, it must be trained using a data corpus in a computationally very intensive process, in which existing systems may typically require weeks to months of time on graphic processing units (GPUs) or central processing units.

As more and more data are included for training and machine learning inference networks, the time required is further exacerbated. Hardware accelerators are more energy efficient than existing GPU-based based approaches, and significantly reduce the energy consumption required for neural network training and inference tasks.

### BRIEF DESCRIPTION OF THE DRAWINGS

FIGS. 1A-1B illustrate example embodiment convolution model instances for implementing a hardware accelerator.

FIG. 2 illustrates, in one example embodiment, an architecture of a platform device, including one or more processors, implementing a convolution model hardware accelerator.

FIG. 3 illustrates a method of operation, in one example embodiment, for implementing a convolution model hardware accelerator.

### DETAILED DESCRIPTION

Among other technical advantages and benefits, solutions herein provide for re-shuffling, or reallocating, an initial order of output filters (also referred to herein as filters, weights or kernels) in a convolution model in a sparsity mode for machine learning inference and training accelerators. Solutions herein recognize that hardware accelerators used for machine learning inference and training workloads often provide higher throughput whilst consuming lower power than CPUs or GPUs. With regard to convolution models in particular, multi-instance machine learning hardware accelerators may be implemented to provide higher throughput compared to a single instance hardware accelerator, further enhancing speed and efficiency with regard to machine learning workloads.

Multi-instance hardware accelerators can be all used for one single machine learning job. For example, all the instances of the hardware accelerator can be used to do machine learning inference work of a single image at the same time, typically for batch one inference. A specific mode, the sparsity mode, utilizes the fact there can be a lot of zeros (0's) in the input feature data and the output filter (or weight) portion of the convolution model. The data and weight with 0's components are not used in multiplication part of the computations in a given machine learning job, and this aspect may be applied using the techniques and systems herein to hardware accelerators to further speed up machine learning tasks. The disclosure herein describes a novel way to re-balance computational loading among the multi-instance convolution model machine learning inference and training hardware accelerators, especially in the sparsity mode, to increase a level of parallelism and reduce overall computational times.

In accordance with a first example embodiment, a method of implementing a convolution model hardware accelerator is provided. The method includes receiving a stream of an input feature map into the one or more processors utilizing a convolution model that includes a plurality of convolution layers, for a given convolution layer within the plurality of convolution layers, reconfiguring a computational order for a plurality of hardware accelerator sub-blocks by re-shuffling a plurality of output filters among the plurality of sub-blocks, and in accordance with the reconfigured computational data flow, generating output features that are interpretive of the input feature map.

In accordance with a second example embodiment, a processing system that includes one or more processors and a memory storing instructions executable in the one or more processor to provide a convolution model hardware accelerator is disclosed. The memory includes instructions executable to receive a stream of an input feature map into the one or more processors utilizing a convolution model that includes a plurality of convolution layers, for a given convolution layer within the plurality of convolution layers, reconfigure a computational order for a plurality of hardware accelerator sub-blocks by re-shuffling a plurality of output filters among the plurality of sub-blocks, and in accordance with the reconfigured computational order, generate output features that are interpretive of the input feature map

In accordance with a third example embodiment, a non-transient memory including instructions executable in one or more processors is provided. The instructions are executable in the one or more processors to implement a convolution model hardware accelerator by receiving a stream of an input feature map into the one or more processors utilizing a convolution model that includes a plurality of convolution layers, for a given convolution layer within the plurality of convolution layers, reconfiguring a computational order for a plurality of hardware accelerator sub-blocks by re-shuffling a plurality of output filters among the plurality of sub-blocks, and in accordance with the reconfigured computational order, generating output features that are interpretive of the input feature map.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device.

Furthermore, one or more embodiments described herein may be implemented through the use of logic instructions that are executable by one or more processors. These instructions may be carried on a computer-readable medium. In particular, machines shown with embodiments herein include processor(s), various forms of memory for storing data and instructions, including interface and associated circuitry. Examples of computer-readable mediums and computer storage mediums include flash memory and portable memory storage units. A processor device as described herein utilizes memory, and logic instructions stored on computer-readable medium. Embodiments described herein may be implemented in the form of computer processor-executable logic instructions in conjunction with programs stored on computer memory mediums, and in varying combinations of hardware in conjunction with the processor-executable instructions or code.

### System Description

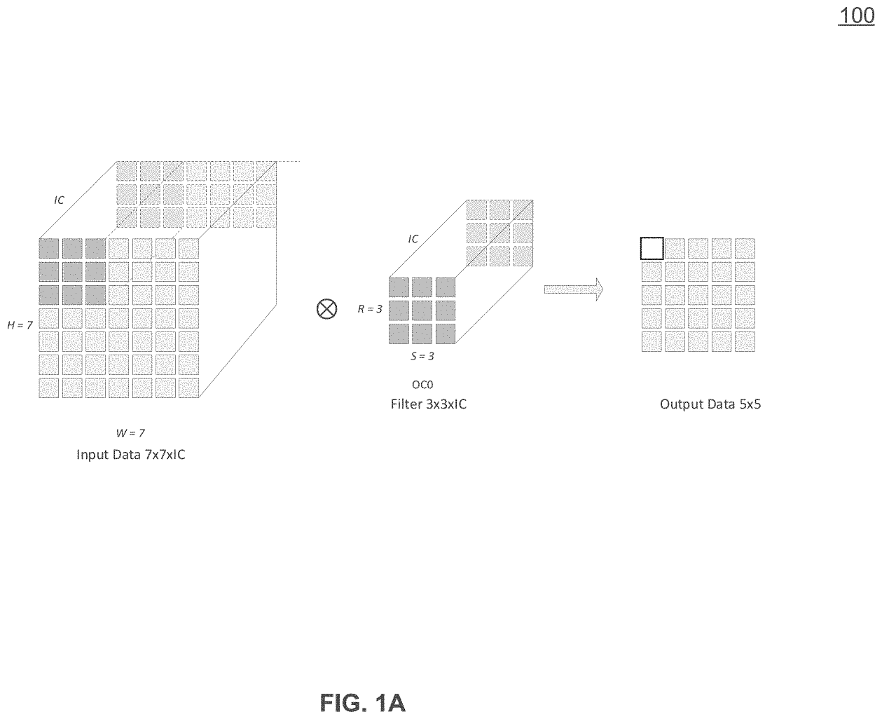

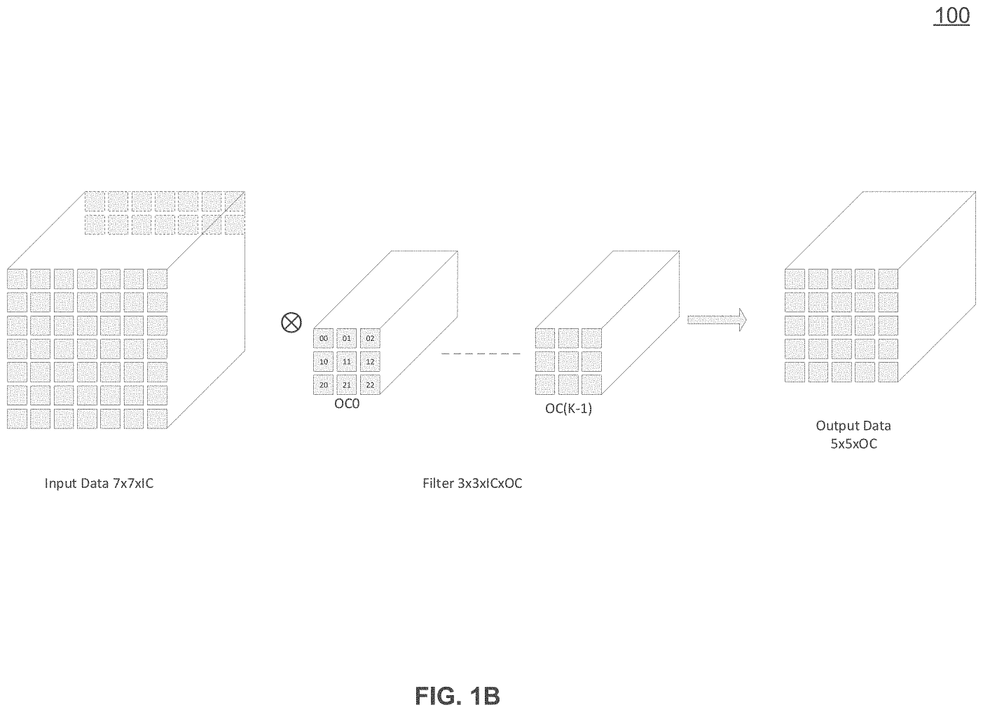

FIG. 1A illustrates, in an example embodiment, a convolution model instance for implementing a hardware accelerator, having a single output filter support. The convolution operation typically embodies two parts of inputs: one is input feature map data, and the other is a filter (variously referred to as output filter, or kernel, or weight). Given the input channel data with W(Width)×H(Height)×IC data cube and R×S×IC filter, the output of direct convolution may be formulated as:

$${y}_{w , h} = {{\sum }^{R - 1}}_{r = 0} {{\sum }^{S - 1}}_{s = 0} {{\sum }^{C - 1}}_{c = 0} {x}_{( w + r ) , ( h + s ) , c} * {w}_{r , s , c}$$

where:
X=input data/input feature/input feature map
w=width of the input or output data
h=height of the input or output data
R=kernel size (width)
S=kernel size (height)
C=number of input channel
Y=output data/output feature/output feature map
W=filter/kernel/weight

FIG. 1A illustrates an input of 7×7×IC, where IC is the number of input channels. The input of 7×7 is used in this example case and the input resolution size can vary. A filter can have different sizes, typical sizes are 1×1, 3×3, 5×5, 7×7, etc. A filter of 3×3 comprises 9 weights (or 9 values) in the example here. For each input channel, the 3×3 filter, or weight, are convoluted with 3×3 data and generates 1 output data. The same location of data of all the input channels are summed together and generate 1 output data channel. The final output of 5×5 output data is shown in FIG. 1A.

An output filter is applied to detect a particular feature of the input map from an input data stream, for example, to detect lines that curve outward and to the right. Other filters may detect other features of the input map, such as for lines that curve to the left or for straight edges. The more filters, the greater the depth of the activation map, and the more information we have about the input volume.

This leads to output channel (OC) definitions. Each OC is represented by an output filter used to detect one particular feature or pattern of the input feature map data stream. FIG. 1A 1 shows 1 output filter (1 OC). Normally in deep learning networks there are many OCs (output filters) to look for different information, features or patterns in the data stream of an input feature map.

FIG. 1B illustrates, in another example embodiment, another convolution model instance for implementing a hardware accelerator; in particular, a convolution model having multiple output filters support. In the example of FIG. 1B, the input feature data is still 7×7×IC. For each output filter, after convolution, a 5×5 output data is generated, as in FIG. 1A. Total of 5×5×OC output data is generated for K-1 number of output channel filters.

Machine learning inference and training networks are typically are modeled to include many convolution layers. Typically, the output of one layer becomes the input of the next layer. For example, in FIG. 1B, if IC of the current layer is 128 and OC is 256, then the input of the current layer is 7×7×128 and the output is 7×7×256. The input of the next layer is 7×7×256.

While hardware accelerators are primarily described in the disclosure herein, it is contemplated that the techniques and system can be extended to central processing unit (CPU) and general purpose processing unit (GPU) implementation of the machine learning inference and training workloads.

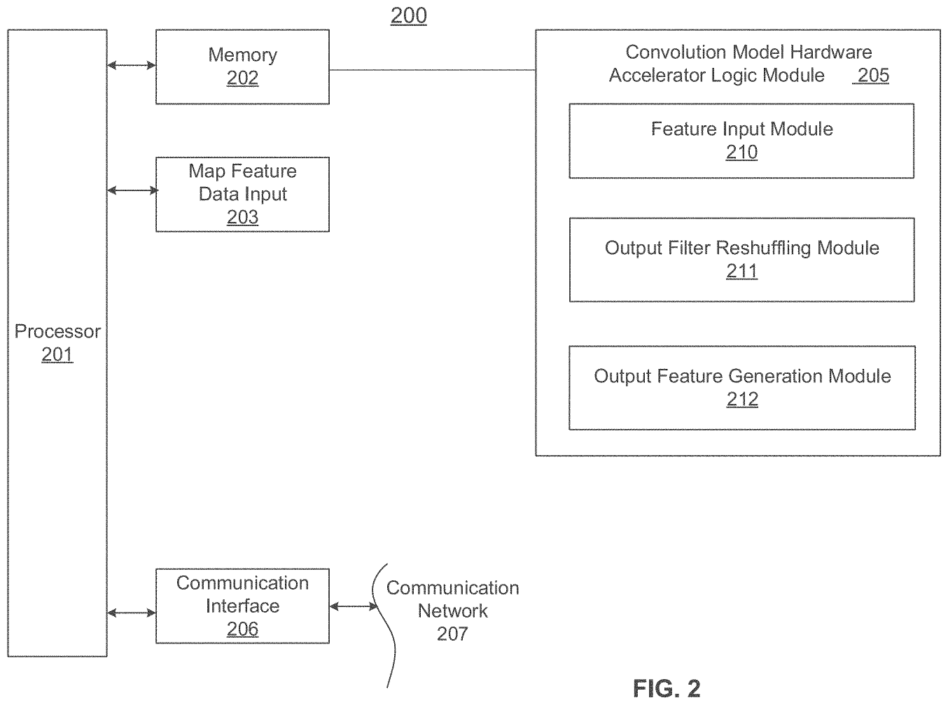

FIG. 2 illustrates, in one example embodiment, an architecture 200 of a platform device or processing system, including one or more processors, implementing a convolution model hardware accelerator.

Convolution model hardware accelerator logic module 205 may include instructions stored in memory 202 executable in conjunction with processor 201. In implementations, the functionality ascribed to processor 201 may be performed using multiple processors deployed in cooperation. Convolution model hardware accelerator logic module 205 may comprise portions or sub-modules including feature input module 210, output filter re-shuffling module 211, and output feature generation module 212. In alternative implementations, it is contemplated that at least some hard-wired circuitry may be used in place of, or in combination with, all or certain portions of the software logic instructions of convolution model hardware accelerator 205 to implement hardware accelerator examples described herein. Thus, the examples described herein are not limited to particular fixed arrangements of hardware circuitry and software instructions.

Feature input module 210 of convolution model hardware accelerator logic module 205 may include instructions executable in processor 201 to receive a stream of an input feature map into the one or more processors utilizing a convolution model that includes a plurality of convolution layers.

Output filter re-shuffling module 211 of convolution model hardware accelerator logic module 205 may include instructions executable in processor 201 to, for a given convolution layer within the plurality of convolution layers, reconfigure a computational order for a plurality of hardware accelerator sub-blocks by re-shuffling a plurality of output filters among the plurality of sub-blocks. In some embodiments, more than one hardware accelerators working in conjunction may be implemented in the processing system.

Output feature generation module 212 of convolution model hardware accelerator logic module 205 may include instructions executable in processor 201 to, in accordance with the reconfigured computational order, generate at least output features that are interpretive of the input feature map.

### Methodology

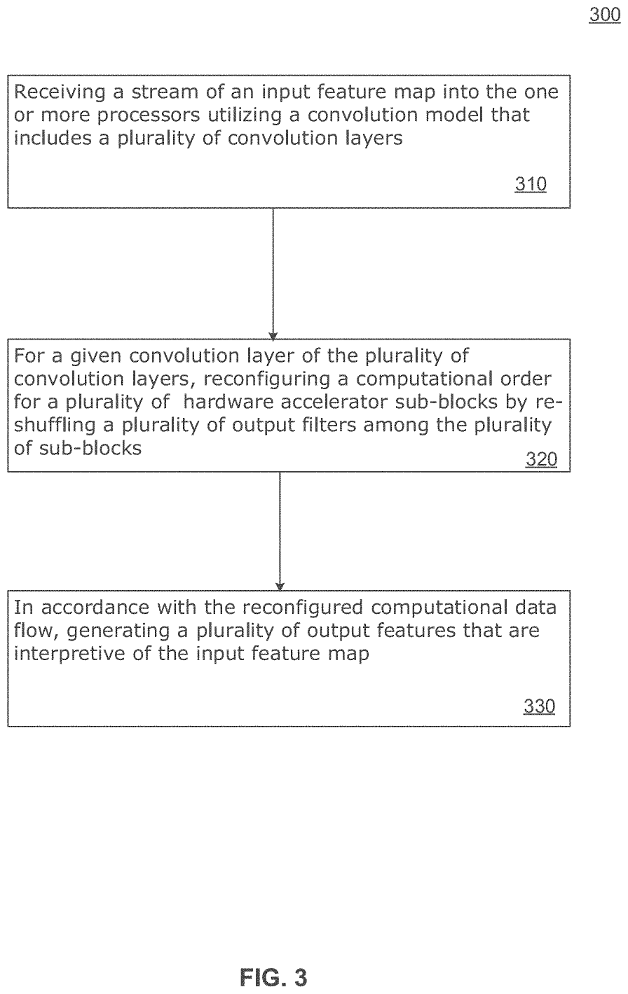

FIG. 3 illustrates, in an example embodiment, method 300 of operation for implementing a convolution model hardware accelerator. In describing the example of FIG. 3, reference is made to the examples of FIG. 1 through FIG. 2 for purposes of illustrating suitable components or elements for performing a step or sub-step being described.

Examples of method steps described herein relate to the use of processing system 200 including convolution model hardware accelerator logic module 205 for implementing the techniques described. According to one embodiment, the techniques are performed in response to the processor 201 executing one or more sequences of software logic instructions that constitute convolution model hardware accelerator logic module 205. In embodiments, convolution model hardware accelerator logic module 205 may include the one or more sequences of instructions within sub-modules including feature input module 210, output filter re-shuffling module 211, and output feature generation module 212. Such instructions may be read into memory 202 from machine-readable medium, such as memory storage devices. In executing the sequences of instructions contained in feature input module 210, output filter re-shuffling module 211, and output feature generation module 212 of convolution model hardware accelerator logic module 205, processor 201 performs the process steps described herein.

In alternative implementations, at least some hard-wired circuitry may be used in place of, or in combination with, the software logic instructions to implement examples described herein. Thus, the examples described herein are not limited to any particular combination of hardware circuitry and software instructions. Additionally, it is also contemplated that in alternative embodiments, the techniques herein, or portions thereof, may be distributed between several processors working in conjunction.

A single instance of hardware accelerator is normally used to process a few numbers of output filters simultaneously. A simple example is as follows: total of 128 output filters (128 OCs), and a hardware accelerator processes 8 OC simultaneously. This will take 16 iterations to process all 128 OCs.

Multi-instance hardware accelerators can be all used for one single machine learning job. For example, all the instances of the hardware accelerator can be used to do machine learning inference work of a single image at the same time.

In the multi-instance hardware accelerators case, a simple example is for each hardware accelerator to process a total number of output filters divide by N, where N is the number of hardware accelerators.

The following network and systems are used to illustrate an example embodiment: 1) a network layer with 128 output weight filters (128 OCs), 2) a hardware accelerator with 8 sub-blocks and each processes 1 OC at a time, so total of 8 OCs simultaneously; 3) 4 parallel hardware accelerators. In this example, it takes 4 iterations to process all 128 OCs.

There are fixed number of multipliers pool in hardware accelerators to do the multiplications/convolutions of the data and weights. Normally, there are a lot of 0's (zeros) in the input feature data and/or weight (in an output filter) portion of the convolution. In the non-sparsity mode (normal mode), multipliers are used to do the multiplications of data and weights even if one or both are zero. In this case, fixed amount of time (a fixed number of hardware clock cycle) is consumed. Therefore, in both single hardware accelerator case or multiple hardware accelerators case, the number of cycles to finish an output channel (OC) are identical, as each sub-block inside hardware accelerator takes about the same amount of time to process an OC.

A specific mode, the sparsity mode, utilizes the fact there can be a lot of 0's (zeros) in the input feature data and/or the weight portion of the convolution. The data and/or weight with 0's components are not used in multiplication part of the machine learning job, and this further speed up the machine learning jobs

In this special sparsity mode case, the number of cycles to process each OC can vary, depends on the number of 0's in the input feature data and also the number of 0's constituted in the output filters.

For example (128 OCs total, a hardware accelerator processes 8 OCs simultaneously, 4 hardware accelerators), there are 32 OCs being processed simultaneously across 4 hardware accelerators. These 32 OCs can finish in different time (in different number of hardware clock cycles) due to different number of 0's in the respective weights of the filters.

This invention describes a novel way to balance the loading among the multi-instance machine learning Inference or training hardware accelerators, especially in the sparsity mode.

In the above example, it takes 16 iterations for one hardware accelerator to process all OCs and 4 iterations for 4 hardware accelerators to process all OCs.

In the case of a single hardware accelerator example, it processes OC0-7 in the first iteration, OC8-15 in the 2nd iteration, and OC120-127 in the 15th iteration. There are 8 sub-blocks in a hardware accelerator. Each sub-block process 1 OC so a single hardware accelerator can process 8 OCs simultaneously. The first sub-block processes OC0, 8, 16, 24, . . . 120, and 2nd sub-block processes OC1, 9, 17, 25, . . . , 121, and 7th sub-block processes OC7, 15, 23, . . . 127. The total process time of the first sub-block is the total time to process OC0, 8, 16, 14, . . . 120.

In the case of 4 hardware accelerators, the first hardware accelerator processes OC0-7 in the first iteration, OC8-15 in the 2nd iteration, OC16-23 in the 3rd iteration, OC24-31 in the 4th iteration. The 2nd hardware accelerator processes OC32-39 in the first iteration, OC40-47 in the 2nd iteration, and so on. The 4th hardware accelerator processes OC96-127 in 4 iterations. The total process time of the first sub-block of the first hardware accelerator is the total time to process OC0, OC8, OC16 and OC24.

Alternatively, in the case of 4 hardware accelerators, the first hardware accelerator processes OC0-7 in the first iteration, OC32-39 in the 2nd iteration, OC64-71 in the 3rd iteration, and so on. The 2nd hardware accelerator processes OC8-15 in the first iteration, OC40-47 in the 2nd iteration and so on. The total process time of the first sub-block of the first hardware accelerator is the total time to process OC0, OC32, OC64 and OC96.

In all the cases above, regardless of one hardware accelerator or 4 hardware accelerators, the OCs assigned to the later iterations are in a fixed pattern and do not take into the considerations of the time or hardware clock cycles consumed by the earlier iterations in the sparsity mode.

In the present invention, the OC assignment of the later iterations take into the consideration of the estimated or actual time consumed by the earlier OC.

Normally, for an OC with weights having many 0's (zero's), less multiplications are needed and hence less time to generate output data for this OC.

Note for 3×3 convolution, filters of OC have size of 3×3×IC, where IC is number of input channels. The number of 0's in 3×3×IC determines number of multiplications needed. Furthermore, when both data sparsity and weight sparsity are considered, the number of 0's in the data along with the number of 0's in 3×3×IC of an OC determines the number of multiplications needed for this OC.

For example, in the filter with 3×3 weight case, there are up to total of 9 non-zero weights in each input channel. A filter of 6 zero weights (3 non-zero weights) takes less multiplications (and hence consumes less time) than a filter with no zero weights (9 valid weights)

In the above example of a single hardware accelerator, take sub-block0 as an example, it's possible that all the OC0, 8, 16, 14, . . . 120 have filters with many 0 weights, while sub-block1 OC1, 9, 17, . . . 121 have filters have little 0 weights. In this case, sub-block1 can take much longer time than sub-block0. This is a non-optimal case as only when all the OCs are finished processing can the current layer of the network completes and move on to the next layer.

The present invention dynamically or statically combines OCs with less 0 weights in the filters with OCs with more 0 weights in the filters in the multiple iterations for the same sub-block of a hardware accelerator. This optimization increases the chances that all the sub-blocks of a hardware accelerator or all the sub-blocks of all the hardware accelerators finish as close to the same time as possible for a given layer of a network.

For example, in the previous example, OC0, 8, 16, 24, . . . 120 all have filters with many 0 weights and they are all assigned to sub-block0, while OC1, 9, 17, 25, . . . 121 all have filters with little 0 and they are all assigned to sub-block1. A simple re-shuffle resulting sub-block0 having OC0, 9, 16, 25 . . . , 121 while sub-block1 having OC1, 8, 17, 24, . . . 120. This makes sure input data of both sub-blocks are multiplied with filters with similar density of 0's. The example here can also be extended to all the sub-blocks of a single hardware accelerator or all the hardware accelerators. The above is an example of re-shuffle/re-allocation only.

The decision how which OCs are assigned to which sub-block during the re-shuffling can be done statically by firmware (controlled by an embedded CPU) or dynamically by hardware. Example of decision criteria for allocating different OCs to different sub-blocks of a hardware accelerator or hardware accelerators: 1) number of non-zero weights in a single output filter, 2) number of non-zero-weights across multiple output filters, 3) data sparsity in combination of the filter/weight sparsity—this can only be done dynamically instead of statically. 4) Actual processing time of a previous iterations

As mentioned, machine learning inference and/or training network typically has many layers of convolutions. Typically, the output of one layer becomes the input of the next layer. For example, in FIG. 2, if IC of the current layer is 128 and OC is 256, then the input of the current layer is 7×7×128 and the output is 7×7×256. The input of the next layer is 7×7×256. In our present invention, OCs are re-allocated across different sub-blocks of hardware accelerator/accelerators. The 256 output channels of 7×7×256 for the current layer (or 256 input channels of 7×7×256 in the next layer), due to re-shuffling or re-allocation of the sub-blocks, are thus subjected to a re-ordering of multiplication operations for the sub-blocks as re-allocated. This does not present a problem to the final summation and output, as all the input channels are summed or added together after the convolution operation, regardless of the particular order.

In an example hardware accelerator operation embodying at least some aspects of the foregoing example embodiments of the disclosure herein, at step 310, processor 201 executes instructions of feature input module 210 to receive a stream of an input feature map into the one or more processors utilizing a convolution model that includes a plurality of convolution layers.

In one aspect, the input feature map comprises an image, which may include a plurality of image features such lines curving to left, to the right, upward or downward, for example.

At step 320, processor 201 of the hardware accelerator executes instructions included in output filter re-shuffling module 211 to for a given convolution layer within the plurality of convolution layers, reconfigure a computational order for a plurality of hardware accelerator sub-blocks by re-shuffling a plurality of output filters among the plurality of sub-blocks.

In one embodiment, reconfiguring the computational data flow comprises, based on identifying at least one of a number of 0's (zeros) in the input feature data and the plurality of output filters associated with at least a set of the plurality of the hardware accelerator sub-blocks.

In one variation, the reallocating, or re-shuffling the order of output filters comprises dynamically re-allocating the output filters amongst the hardware accelerator sub-blocks in a hardware implementation.

In another variation, the re-shuffling comprises statically re-allocating the output filters amongst the hardware accelerator sub-blocks in a firmware implementation controlled by an embedded central processing unit (CPU).

In embodiments, as a result of the re-shuffling of the output filters, the processing time is reduced for the given convolution layer to which the hardware accelerator technique and system is being applied.

At step 330, processor 201 executes instructions included in output filter re-shuffling module 211 to, in accordance with the reconfigured computational order, generate output features that are interpretive of the input feature map.

It is contemplated that the convolution model hardware accelerator may be implemented in one or more of a field-programmable gate array (FPGA) device, a massively parallel processor array device, a graphics processing unit (GPU) device, a central processing unit (CPU) device, and an application-specific integrated circuit (ASIC).

It is contemplated that embodiments described herein be extended and applicable to individual elements and concepts described herein, independently of other concepts, ideas or system, as well as for embodiments to include combinations of elements in conjunction with combinations of steps recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, any absence of describing combinations does not preclude the inventors from claiming rights to such combinations.

What is claimed is:

1. A method for implementing a convolution model hardware accelerator in one or more processors, the method comprising:
receiving a stream of an input feature map into the one or more processors, the input feature map utilizing a convolution model that includes a plurality of convolution layers;
for a given convolution layer within the plurality of convolution layers, reconfiguring a computational order for a plurality of hardware accelerator sub-blocks by re-shuffling a plurality of output filters among the plurality of sub-blocks; and
in accordance with the reconfigured computational order, generating a plurality of output features that are interpretive of the input feature map.

2. The method of claim 1, wherein reconfiguring the computational order further comprises identifying at least one of a number of 0's (zeros) in the input feature data and the output filters associated with at least a set of the plurality of hardware accelerator sub-blocks.

3. The method of claim 2, further comprising dynamically re-allocating respective ones of the plurality of output filters amongst the hardware accelerator sub-blocks in a hardware implementation.

4. The method of claim 2, further comprising statically re-allocating respective ones of the plurality of output filters amongst the hardware accelerator sub-blocks in a firmware implementation controlled by an embedded central processing unit (CPU).

5. The method of claim 2, wherein reconfiguring the computational order minimizes the processing time for the given convolution layer.

6. The method of claim 1, wherein the convolution model hardware accelerator is implemented in one or more of a field-programmable gate array (FPGA) device, a massively parallel processor array device, a graphics processing unit (GPU) device, a central processing unit (CPU) device, and an application-specific integrated circuit (ASIC).

7. The method of claim 1, wherein the input feature map comprises an image.

8. A processing system comprising:
one or more processors;
a non-transient memory storing instructions executable in the one or more processors to implement a convolution model hardware accelerator by:
receiving a stream of an input feature map into the one or more processors, the input feature map utilizing a convolution model that includes a plurality of convolution layers;
for a given convolution layer within the plurality of convolution layers, reconfiguring a computational order for a plurality of hardware accelerator sub-blocks by re-shuffling a plurality of output filters among the plurality of sub-blocks; and
in accordance with the reconfigured computational order, generating a plurality of output features that are interpretive of the input feature map.

9. The processing system of claim 8, wherein reconfiguring the computational order further comprises identifying at least one of a number of 0's (zeros) in the input feature data and the plurality of output filters associated with at least a set of the plurality of hardware accelerator sub-blocks.

10. The processing system of claim 9, further comprising dynamically re-allocating respective ones of the plurality of output filters amongst the hardware accelerator sub-blocks in a hardware implementation.

11. The processing system of claim 9, further comprising statically re-allocating respective ones of the plurality of output filters amongst the hardware accelerator sub-blocks in a firmware implementation controlled by an embedded central processing unit (CPU).

12. The processing system of claim 8, wherein reconfiguring the computational order minimizes the processing time for the given convolution layer.

13. The processing system of claim 8, wherein the convolution model hardware accelerator is implemented in one or more of a field-programmable gate array (FPGA) device, a massively parallel processor array device, a graphics processing unit (GPU) device, a central processing unit (CPU) device, and an application-specific integrated circuit (ASIC).

14. The processing system of claim 8, wherein the input feature map comprises an image.

15. The processing system of claim 8, wherein the hardware accelerator is a first hardware accelerator, and further comprising at least a second hardware accelerator.

16. A non-transient processor-readable memory including instructions executable in one or more processors to:
receive a stream of an input feature map into the one or more processors, the input feature map utilizing a convolution model that includes a plurality of convolution layers;
for a given convolution layer within the plurality of convolution layers, reconfiguring a computational order for a plurality of hardware accelerator sub-blocks by re-shuffling a plurality of output filters among the plurality of sub-blocks; and
in accordance with the reconfigured computational, generate a plurality of output features that are interpretive of the input feature map.
